(19) United States
(12) Patent Application Publication
(10) Pub. No.: US 2013/0321710 A1
(43) Pub. Date: Dec. 5, 2013

(54) IMAGE DISPLAY DEVICE AND TELEVISION RECEIVER

(71) Applicant: Panasonic Corporation, Osaka (JP)

(72) Inventors: Yoshirou KAWASOE, Osaka (JP); Masatoshi HORI, Osaka (JP); Masaki KAWANAKA, Osaka (JP)

(73) Assignee: PANASONIC CORPORATION, Osaka (JP)

(21) Appl. No.: 13/900,908

(22) Filed: May 23, 2013

(30) Foreign Application Priority Data
May 29, 2012 (JP) 2012-122291

(51) Int. Cl. H01J 5/16; H04N 5/64

(52) U.S. Cl. CPC H01J 5/16; H04N 5/64
USPC 348/731; 250/423 R

(57) ABSTRACT

An image display device has a display panel which displays an image; a first case which accommodates the display panel; an ion generating unit which generates ion mist; a second case which accommodates therein the ion generating unit; and a blower which is disposed inside the second case, and generates an air flow for emitting the ion mist generated by the ion generating unit to outside of the second case. The second case has an inlet provided upstream in the air flow relative to the ion generating unit; and an outlet for emitting air flowing in from the inlet and including the ion mist generated by the ion generating unit to the outside of the second case. The air including the ion mist and emitted from the outlet is emitted to a viewing space in front of the display panel.

### CROSS REFERENCE TO RELATED APPLICATION

The present application is based on and claims priority of Japanese Patent Application No. 2012-122291 filed on May 29, 2012.

The entire disclosure of the above-identified application, including the specification, drawings and claims is incorporated herein by reference in its entirety.

### FIELD

The present disclosure relates to image display devices, and in particular to an image display device having a function of generating ion mist.

### BACKGROUND

It is known that nano-sized mist negative ions having strong electric charge (hereinafter, referred to as “ion mist”) exhibit effects of, for example, capturing dust floating in the air, moisturizing skin and hair, eliminating odors and germs, and the like.

For example, Japanese Unexamined Patent Application Publication No. 2010-264455 discloses an electrostatic atomizer which generates ion mist. This electrostatic atomizer generates ion mist by applying a high voltage to an electrode in a state where dew condenses in the vicinity of the electrode. In addition, various electric appliances having a function of generating ion mist such as a cleaner, a hair drier, a washing machine, and a refrigerator are known.

### SUMMARY

An image display device according to an aspect of the present disclosure includes a display panel displaying an image; a first case accommodating the display panel; an ion generating unit generating ion mist; a second case accommodating the ion generation unit; and a blower disposed inside the second case and generating an air flow for emitting the ion mist generated by the ion generating unit to outside of the second case. The second case includes an air inlet provided in an upstream side of the ion generating unit; and an air outlet for emitting the air including the ion mist generated by the ion generating unit to the outside of the second case. The air including the ion mist is emitted to a viewing space in front of the display panel.

### BRIEF DESCRIPTION OF DRAWINGS

FIG. 1 is a perspective view illustrating an appearance of a front side of a television receiver 10.

FIG. 2 is a perspective view illustrating an appearance of a rear side of the television receiver 10.

FIG. 3 illustrates an internal structure of the television receiver 10. FIG. 4 illustrates the back of a rear cover 40.

FIG. 5 is a perspective view of a top side (front side) of a case 140.

FIG. 6 is a perspective view of an underside (backside) of the case 140.

FIG. 7 illustrates a plan view of an upper area 141 of the case 140, and a back view of a cover 150.

FIG. 8 illustrates a structure of an inlet 112a in a second air course 112.

FIG. 9 is a schematic diagram illustrating a configuration of an ion generating unit 113.

FIG. 10 is a perspective view illustrating a positional relationship between a louver 50 and a light source 60.

FIG. 11 is an enlarged front view of the louver 50 and the light source 60.

### DESCRIPTION OF EMBODIMENT

The following describes an embodiment in detail, with reference to the accompanying drawings when necessary. It should be noted that an unnecessarily detailed description may be omitted. For example, a detailed description of a matter already known well and a redundant description of substantially the same configuration may be omitted. This aims at avoiding the following description being unnecessarily redundant and facilitating understanding of those skilled in the art.

It should be noted that the inventors provide the accompanying drawings and the description below in order that those skilled in the art sufficiently understand the present disclosure, and thus do not intend to limit subject matters recited in the appended claims by these.

### 1. Configuration of Television Receiver 10

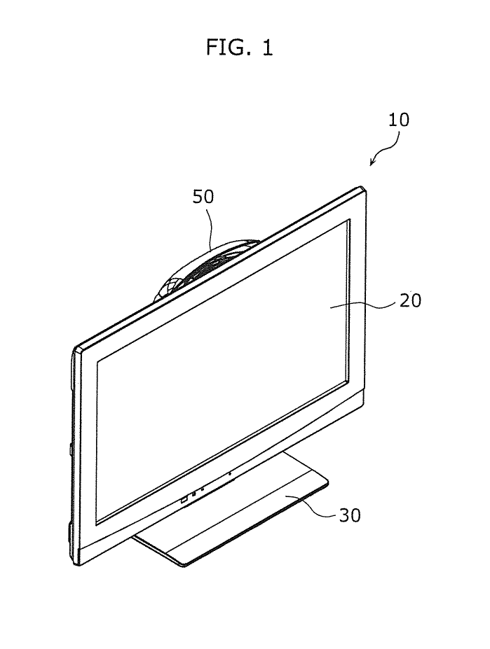

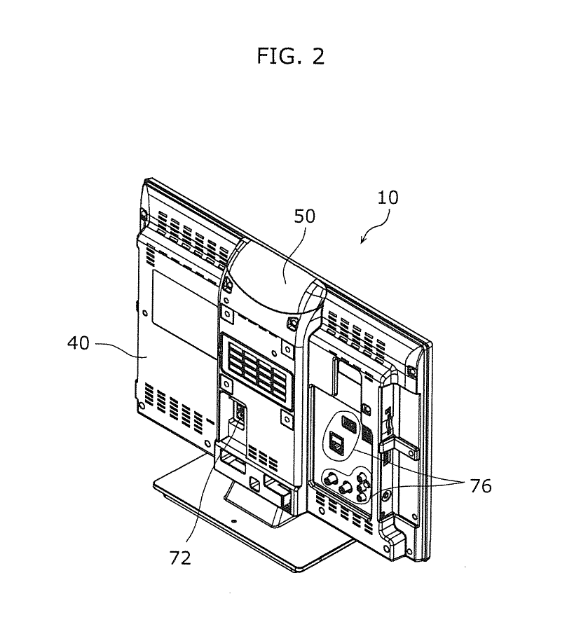

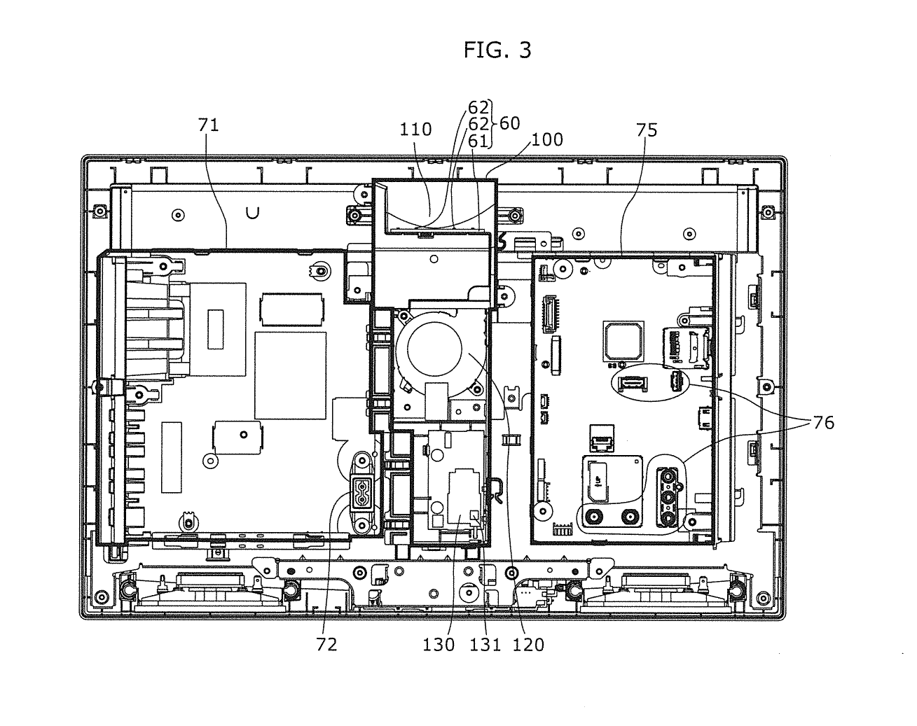

A description is given of a configuration of a television receiver 10 which is an example of an image display device according to the present embodiment, with reference to FIGS. 1 to 4. FIG. 1 is an appearance perspective view of a front side of the television receiver 10. FIG. 2 is an appearance perspective view of a rear side of the television receiver 10. FIG. 3 illustrates an internal structure of the television receiver 10. FIG. 4 illustrates the back (inner side) of a rear cover 40.

The television receiver 10 mainly includes a display panel 20, a base 30, the rear cover 40, and a louver 50, as illustrated in FIGS. 1 and 2.

The display panel 20 displays images (video). Examples of the display panel 20 include a liquid crystal panel, a plasma panel, and the like.

The base 30 supports the display panel 20.

The rear cover 40 is an example of a first case, and in the present embodiment, the rear cover 40 covers the back of the display panel 20. In the space formed between the display panel 20 and the rear cover 40, a power supply circuit 71, a signal processing circuit 75, and an ion mist emitting unit 100 are disposed on the back of the display panel 20, as illustrated in FIG. 3.

In the example in FIG. 3, the ion mist emitting unit 100 is disposed in the center of the space on the back of the display panel 20 (rear side), the power supply circuit 71 is disposed on the left of the ion mist emitting unit 100, and the signal processing circuit 75 is disposed on the right of the ion mist emitting unit 100. However, it should be noted that the disposition thereof is not limited to the example in FIG. 3.

The power supply circuit 71 is a circuit which supplies power to the display panel 20, the signal processing circuit 75, and the ion mist emitting unit 100. The power supply circuit 71 has a power socket 72 into which the power supply plug for supplying external power is inserted. In the example in FIG. 3, the power socket 72 is disposed on the lower right of the power supply circuit 71 (on a side close to the ion mist emitting unit 100).

The signal processing circuit 75 is a circuit which, for instance, processes image signals for the display on the display panel 20. The signal processing circuit 75 includes a demultiplexer which separates image signals from broadcast waves received by a tuner, a decoder which decodes separated video/audio signals, and the like.

The ion mist emitting unit 100 generates ion mist upon reception of power supply from the power supply circuit 71, and emits the generated ion mist toward the upper side of the television receiver 10 (see FIG. 3).

The ion mist emitting unit 100, the display panel 20, and the signal processing circuit 75 receive power supply from the power supply circuit 71 independently from one another. The ion mist emitting unit 100 can thereby emit ion mist even in a state where images are not displayed on the display panel 20.

As illustrated in FIGS. 3 and 4, the ion mist emitting unit 100 includes: an ion generating unit 110 which generates ion mist; a fan (blower) 120 for emitting ion mist generated by the ion generating unit 110 to the outside; a control circuit 130 which controls operation of the ion generating unit 110 and the fan 120; and a case 140 which holds the ion generating unit 110, the fan 120, and the control circuit 130. The case 140 is an example of a second case.

As illustrated in FIG. 4, the rear cover 40 has a vent 43 formed at a position facing the center portion of the ion mist emitting unit 100 (or in other words, a position facing the fan 120).

The louver 50 is attached to the center portion of a top edge of the rear cover 40, as illustrated in FIGS. 1 and 2. The louver 50 functions as a guide member which guides ion mist emitted from the ion mist emitting unit 100 to a viewing space. Furthermore, the louver 50 also functions as an indicator showing that ion mist is being emitted from the ion mist emitting unit 100.

### 2. Configuration of Ion Mist Emitting Unit 100

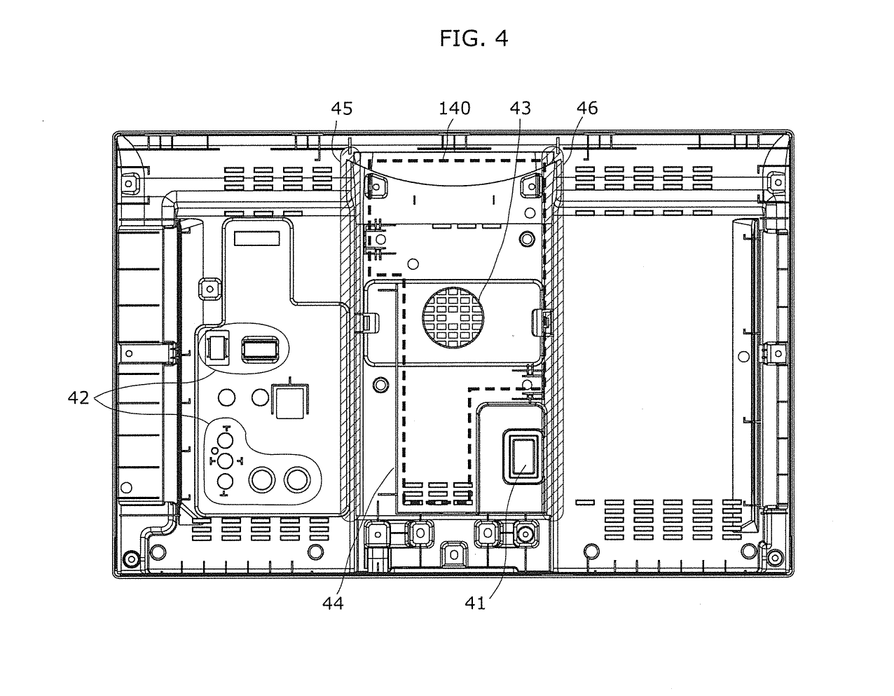

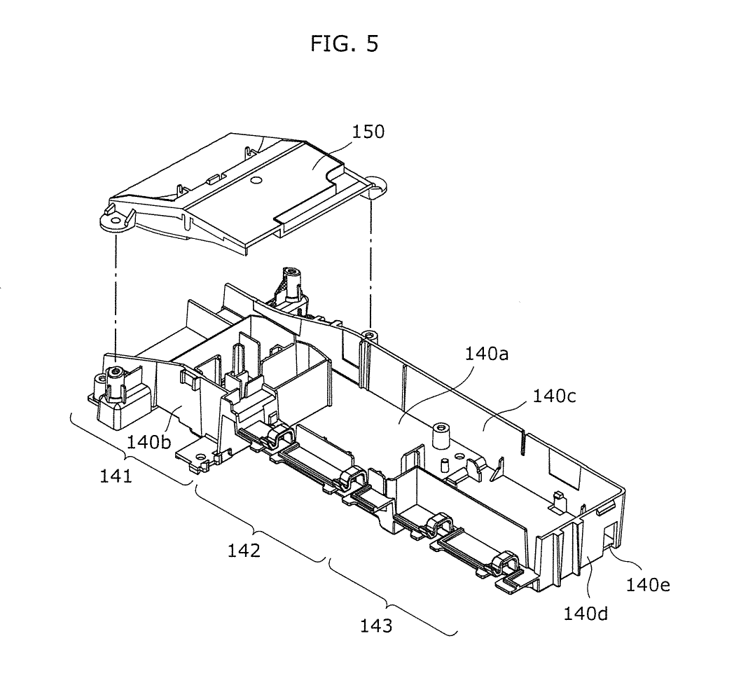

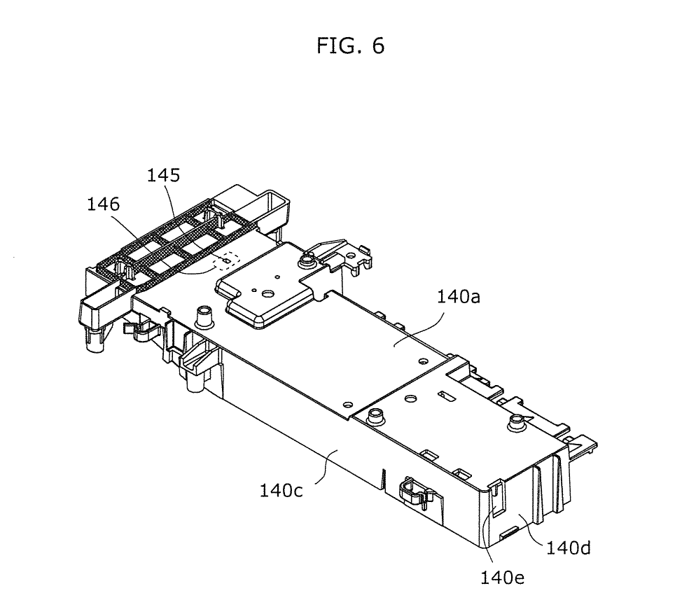

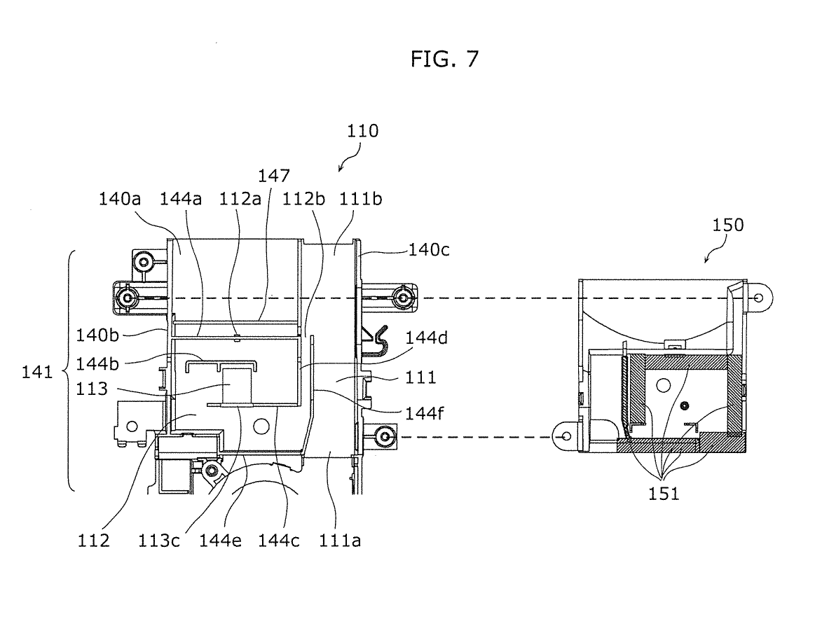

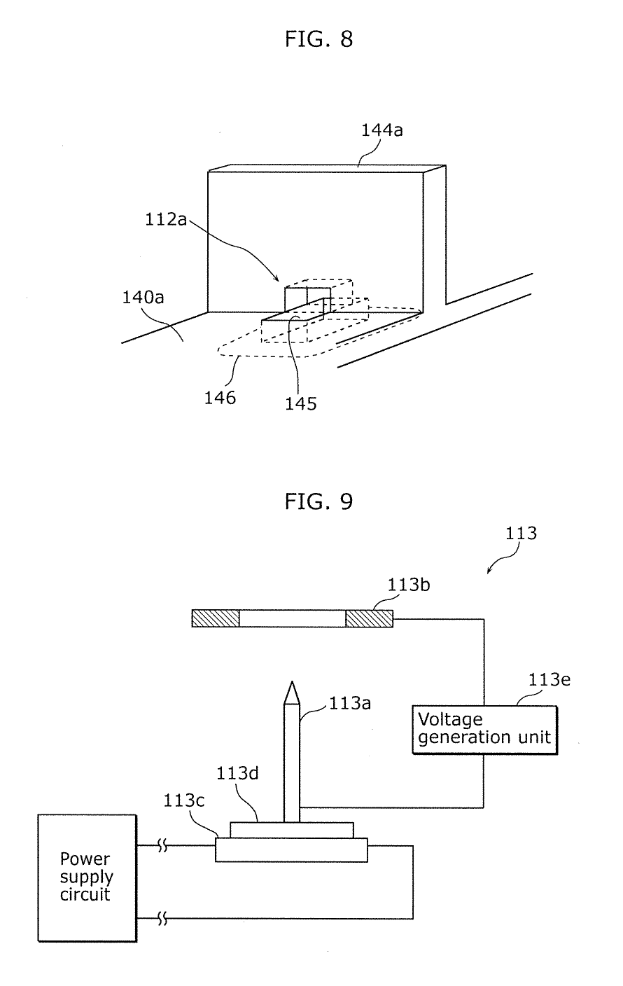

The following describes the configuration of the ion mist emitting unit 100, with reference to FIGS. 5 to 9. FIG. 5 is a perspective view of a top side (front side) of the case 140. FIG. 6 is a perspective view of an underside (backside) of the case 140. FIG. 7 illustrates a plan view of an upper area 141 of the case 140, and a back view of a cover 150. FIG. 8 schematically illustrates the structure of an inlet 112a in a second air course 112. FIG. 9 is a schematic diagram illustrating a configuration of an ion generating unit 113.

First, the case 140 is attached onto the back of the display panel 20 as illustrated in FIGS. 3 and 5. The case 140 has separate areas, namely, the upper area (first area) 141 in which the ion generating unit 110 is held, a center area (second area) 142 in which the fan 120 is held, and a lower area (third area) 143 in which the control circuit 130 is held.

Furthermore, the case 140 is enclosed by a front wall 140a and three side walls 140b, 140c, and 140d, as illustrated in FIGS. 5 and 6. The front wall 140a is an example of a second wall. The upper area 141 of the case 140 is covered with the cover 150.

The center area 142 and the lower area 143 of the case 140 are covered with the rear cover 40. Projecting portions 44, 45, and 46 are formed at positions surrounding the outside of the case 140.

As illustrated in FIG. 2, a portion of the rear cover 40 corresponding to the ion mist emitting unit 100 is projecting on the rear side relative to the portions corresponding to the power supply circuit 71 and the signal processing circuit 75.

The ion mist emitting unit 100 can be thermally isolated from a drive circuit and the display panel 20 because they are enclosed by the case 140 and the cover 150, as described above. This helps preventing propagation of heat generated by the power supply circuit 71 and the signal processing circuit 75 to the ion generating unit 110 and the control circuit 130.

In the upper area 141 of the case 140, a first air course 111 and a second air course 112 are formed by the front wall 140a and the side walls 140b and 140c which are outer walls of the case 140, multiple partitions 144a, 144b, 144c, 144d, 144e, and 144f which divide the inside of the case 140, and the cover 150. The partition 144a is an example of a first wall. Further, the ion generating unit 113 is disposed in the second air course 112.

As illustrated in FIG. 7, the first air course 111 represents a space between an inlet 111a and an outlet 111b and is provided in the vertical direction, in an area on the right of the upper area 141.

The inlet 111a communicates with the center area 142 of the case 140. The outlet 111b communicates with the outside of the case 140.

As illustrated in FIG. 7, the second air course 112 represents a space between the inlet 112a and an outlet 112b, and is formed on the left of the first air course 111. The inlet 112a is provided in a bottom portion of the partition 144a (the display panel 20 side). The outlet 112b is provided at a position facing the first air course 111. Specifically, the second air course 112 joins the first air course 111 at the position of the outlet 112b. In addition, the second air course 112 has a narrower width in the upstream from this junction than the first air course 111.

The inlet 112a in the second air course 112 according to the present embodiment is formed as illustrated in FIGS. 6 and 8, for example. A through hole 145 penetrating the partition 144a is formed at a portion where the front wall 140a of the case 140 and the partition 144a are connected.

The case 140 according to the present embodiment is made of resin to reduce cost and weight. When the case is made by resin mold, it is difficult to provide the through hole 145 only in the partition 144a on account of the molding process. Thus, the through hole 145 is unavoidably provided in the front wall 140a.

However, if the heat generated by the display panel 20 is conducted from the front wall 140a side (=where the front wall 140a is facing the back of the display panel 20), the ion generating unit 113 is heated, which exerts a harmful effect.

In view of this, the opening of the through hole 145 on the outer side of the case 140 (namely, the back of the case 140) is closed by a seal 146 as illustrated in FIG. 6. In this manner, the inlet 112a in the second air course 112 is formed.

In an area above the partition 144a, a shield wall 147 is formed in order to prevent foreign substances (dust, waterdrop, and the like) from getting into the inlet 112a. The shield wall 147 has a lower height than the partition 144a, and thus a small space, which allows air to flow into the inlet 112a, is formed between the shield wall 147 and the cover 150 in a state where the cover 150 is attached to the case 140.

Next, as illustrated in FIG. 7, non-woven fabric pieces 151 are attached on the backside of the cover 150 at positions facing the side wall 140b and the partitions 144a, 144d, 144e, and 144f which separate the inside and outside of the second air course 112. Putting the cover 150 on the case 140 brings the non-woven fabric pieces 151 into close contact with the top surfaces of the partitions 144a, 144d, 144e, and 144f, thereby maintaining an airtight condition at the top of the upper area 141 (in particular, the second air course 112) of the case 140. It should be noted that other materials such as rubber may be used instead of the non-woven fabric pieces 151.

The above configuration prevents air from flowing into the second air course 112 via portions other than the inlet 112a and the outlet 112b and furthermore prevents air from flowing out of the second air course 112 via portions other than the inlet 112a and the outlet 112b. Thus, the second air course 112 is maintained in an airtight condition in portions other than the inlet 112a and the outlet 112b.

The ion generating unit 113 is held in an area enclosed by the partitions 144b and 144c in the second air course 112, as illustrated in FIG. 7. In other words, the ion generating unit 113 is disposed on the upstream side of the junction of the first air course 111 and the second air course 112.

As illustrated in FIG. 9, the ion generating unit 113 includes a pair of electrodes 113a and 113b which are disposed separately, a Peltier device 113c which causes dew condensation when the pair of electrodes 113a and 113b are cooled, an insulating member 113d disposed between the electrode 113a and the Peltier device 113c, and a voltage generation unit 113e which applies a high voltage across the pair of electrodes 113a and 113b.

In the ion generating unit 113, a voltage is applied to the Peltier device 113c, whereby the Peltier device 113c is cooled and dew condensation is caused. Then electricity is discharged in the water drops, thereby generating ion mist. Specifically, upon reception of a voltage supplied from the control circuit 130, the temperature of the Peltier device 113c becomes lower on the top side near the pair of electrodes 113a and 113b (heat absorption side), and the temperature becomes higher on the bottom side (heat dissipation side). The insulating member 113d electrically insulates the electrode 113a from the Peltier device 113c, and thermally connects the electrode 113a and the Peltier device 113c. As a result, dew condensation occurs on the electrode 113a cooled by the Peltier device 113c. When a high voltage (3500 V, for example) is applied across the pair of electrodes 113a and 113b by the voltage generation unit 113e, corona-discharge, which occurs between the pair of electrodes 113a and 113b, generates mist negative ions wrapped in water particles (ion mist having a diameter of 5 to 20 nm).

The operation of the Peltier device 113c differs depending on an environmental temperature. For example, dew hardly condenses when the temperature is high, and thus it is necessary to cool the Peltier device 113c by applying a higher voltage thereto and vice versa when the temperature is low. On this account, a temperature sensor 131 which measures the temperature is provided on the substrate of the control circuit 130. The control circuit 130 controls the voltage supplied to the Peltier device 113c based on the temperature measured by the temperature sensor 131.

It is preferable to provide the temperature sensor 131 in the vicinity of the Peltier device 113c in order to accurately measure the temperature of the Peltier device 113c; however, the temperature sensor 131 is provided at a position distant from the Peltier device 113c (on the control circuit 130) in the present embodiment in the light of reducing space for the case 140 and the design of the second air course 112. For this reason, the temperature sensor 131 needs to be able to accurately measure a change in the temperature of the Peltier device 113c.

For example, when the temperature measured by the temperature sensor 131 is constant although the temperature of the Peltier device 113c is increasing due to external factors (such as rise of temperature of the display panel 20 and the power supply circuit 71), the malfunction of the Peltier device 113c may be caused. In view of this, the case 140 has a substantially sealed structure also for eliminating such external factors. Accordingly, the inside of the case 140 is thermally isolated from the power supply circuit 71 and the display panel 20.

In the above configuration, if the fan 120 (see FIG. 3) is rotated, the air supplied from the vent 43 in the rear cover 40 flows into the first air course 111 through the inlet 111a, and flows out from the outlet 111b. This also exhausts air in the second air course 112 forcibly.

Specifically, air flowing from the inlet 112a into the second air course 112 captures ion mist generated by the ion generating unit 113 when passing through along the partitions 144b to 144e, for instance. Then the air including ion mist is guided by the partitions 144d and 144f in the same direction as the flow in the first air course 111, and flows out from the outlet 112b into the first air course 111. As a result, the ion mist generated by the ion generating unit 113 is emitted by the louver 50 to the viewing space in front of the display panel 20.

When the ion generating unit 113 is directly exposed to the air-flow generated by the fan 120, the dew condensation occurring on the pair of electrodes 113a and 113b may be evaporated. In view of this, negative pressure is caused in the vicinity of the outlet 112b by the air-flow generated by the fan 120 as in the above configuration. The evaporation is prevented by the airflow which is thus caused by the negative pressure in the second air course 112.

If the surface of the Peltier device 113c is not sufficiently cooled on the heat dissipation side, the cooling efficiency falls on the heat absorption side. In view of this, in the ion generating unit 113, the surface of the Peltier device 113c on the heat dissipation side (the surface facing the partition 144e) is exposed in the second air course 112 from the opening provided in the partition 144c. Accordingly, the air in the second air course 112 carries the ion mist generated by the ion generating unit 113 to the outlet 112b, and furthermore cools the surface of the Peltier device 113c on the heat dissipation side.

Air is supplied to the fan 120 from the vent 43 in the rear cover 40, for instance.

The fan 120 has a function of diffusing ion mist generated by the ion generating unit 113 to a viewing space, and a function of cooling constituent elements of the ion mist emitting unit 100 (in particular, the surface of the Peltier device 113c on the heat dissipation side and the control circuit 130). The fan 120 is not used for cooling the power supply circuit 71 and the signal processing circuit 75 in the present embodiment, and is provided essentially for cooling the ion mist emitting unit 100 only.

Here, from a viewpoint of increasing the flexibility of routing a power cable to the television receiver 10, it is preferable to dispose the power socket 72 at a position near the center of the back of the display panel 20 in the horizontal direction. For that purpose, it is necessary to decrease the lateral width of the ion mist emitting unit 100.

Meanwhile, it is necessary to increase the capacity of the second air course 112 in order to generate a sufficient amount of ion mist. Accordingly, it is difficult to decrease the lateral width of the upper area 141 of the case 140.

In view of this, in the present embodiment, the lateral width of the lower area 143 of the case 140 adjacent to the power socket 72 is smaller than the lateral widths of the upper area 141 and the center area 142, as illustrated in FIGS. 3 and 5.

### 3. Configuration of Louver 50

As illustrated in FIGS. 1 and 2, the louver 50 is attached to the center portion of the upper edge of the rear cover 40, and shaped to have a curved surface. The louver 50 provides the ion mist which is emitted upwards from the unit 100, to the front side of the display panel 20 (a viewing space).

The louver 50 can also inform a user when the ion mist is emitted from the unit 100.

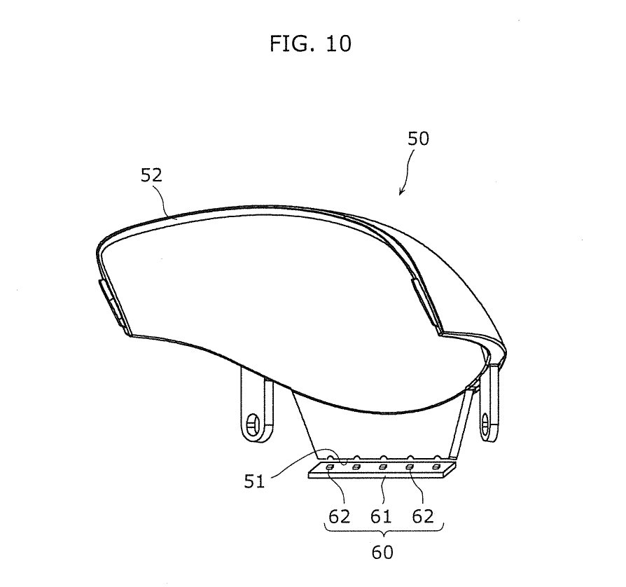

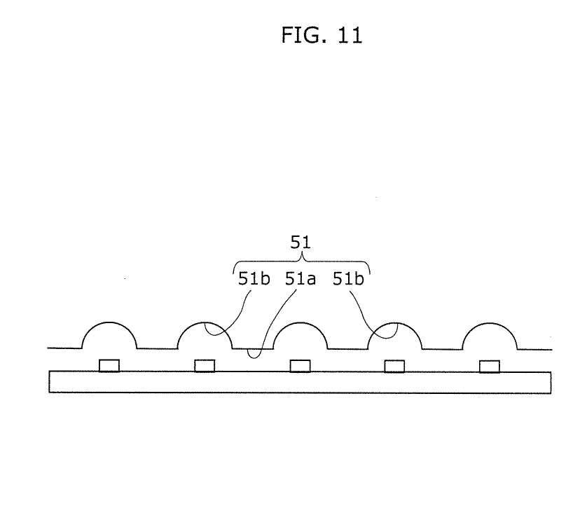

FIG. 10 is a perspective view illustrating the positional relationship between the louver 50 and a light source 60. FIG. 11 is an enlarged front view at a position where the louver 50 and the light source 60 face each other.

The louver 50 is formed using, for example, a transparent material (typically, resin material) and has a first edge surface 51 facing the light source 60 and a second edge surface 52 facing the viewing space.

The light source 60 includes a substrate 61 and a plurality of light emitting diode (LED) elements 62 disposed at predetermined intervals on the surface of the substrate 61. Then as illustrated in FIG. 3, the light source 60 is installed in a state where the LED elements 62 are facing upwards.

The control circuit 130 turns on the LED elements 62 of the light source 60 while the ion mist emitting unit 100 is emitting the ion mist. The light emitted from the LED elements 62 are incident on the first edge surface 51 of the louver 50 and passes through the inside of the louver 50. Some of the light is emitted from the outer surface (surface of the curved surface portion) of the louver 50, and some of the light is emitted from the second edge surface 52. Accordingly, a whole outer surface (the curved surface) of the louver 50 and the second edge surface 52 of the louver 50 appear gleaming to a user in the viewing space.

The louver 50 is formed of a colorless transparent resin in order to increase the transmissivity of the light entering from the first edge surface 51. This is for increasing the amount of incident light from the light source 60. In contrast, the louver 50 may have a surface coated in a given color. Specifically, the combination of the color of the surface of the louver 50 and the color of light emitted by the LED elements 62 can determine the color of light emitted from the surface of the louver 50. The second edge surface 52 can also be coated in a given color, similarly.

The second edge surface 52 has a rough surface so that light passing through the inside of the louver 50 is reflected diffusely. On the other hand, the first edge surface 51 has a smooth surface so that the amount of incident light from the light source 60 increases.

In short, the surface of the second edge surface 52 is rougher than the first edge surface 51.

The first edge surface 51 has multiple surfaces, which are facing in crossing directions, in order to diffuse the incident light from the light source 60 to the entire louver 50.

The louver 50 is used not only for informing the emission of ion mist from the ion mist emitting unit 100. For example, the signal processing circuit 75 may turn on the light source 60 when emergency broadcast is received via a tuner.

A description is given in the above embodiment using the television receiver 10 as an example of an image display device. However, the image display device is not limited to this. The present disclosure is applicable to, for example, a display of a personal computer, a monitor which does not include a tuner, and the like.

### 4. Advantage

Among conventional electric appliances provided with a function of generating ion mist, cleaners and hair driers emit ion mist only when the appliances are used. Washing machines and refrigerators emit ion mist only inside thereof. The ion mist emitted from these electric appliances thereby exhibits the effects merely in a range limited temporally and spatially.

A television receiver is usually installed in a room in a state where the display panel faces towards a user's living space. Thus, if ion mist is emitted towards the space in front of the display panel of the television receiver, ion mist can be efficiently supplied to the user or to the living space of the user.

Although it is preferable to increase the output of a blower for diffusing ion mist so that the ion mist can spread over the entire large viewing space, the dew condensation occurring around an electrode is evaporated thereby decreasing efficiency of generating ion mist if the ion generating unit is exposed directly to the air sent from the blower.

The present disclosure provides a solution to this problem.

The above is a description of the embodiment as an example of the technology according to the present disclosure. The accompanying drawings and a detailed description are thus provided.

Therefore, constituent elements illustrated in the accompanying drawings and described in the detailed description may include not only constituent elements necessary for addressing the problem, but also constituent elements unnecessary for addressing the problem, in order to illustrate the above technique. Accordingly, a fact that such unnecessary constituent elements are illustrated in the accompanying drawings and described in the detailed description should not immediately lead to an acknowledgement that those unnecessary constituent elements are required.

In addition, the embodiment described above is aimed at illustrating the technique according to the present disclosure, and thus various changes, replacement, addition, omission, and the like can be performed within the scope of claims and equivalent thereof.

### INDUSTRIAL APPLICABILITY

The present disclosure is applicable to image display devices such as a television receiver.

1. An image display device comprising:
a display panel displaying an image;
a first case accommodating the display panel;
an ion generating unit generating ion mist;
a second case accommodating the ion generation unit; and
a blower disposed inside the second case and generating an air flow for emitting the ion mist generated by the ion generating unit to outside of the second case, wherein
the second case includes:
an air inlet provided in an upstream side of the ion generating unit; and
an air outlet for emitting the air including the ion mist generated by the ion generating unit to the outside of the second case, and wherein
the air including the ion mist is emitted to a viewing space in front of the display panel.

2. The image display device according to claim 1, wherein the second case includes:
a first wall disposed perpendicular to aback surface of the display panel and having the air inlet formed therein;
a second wall disposed parallel to the back surface of the display panel and having a through hole penetrating a section crossing the first wall; and
a covering member covering the through hole.

3. The image display device according to claim 1, further comprising
a control circuit controlling an operation of the ion generating unit and the blower in the second case.

4. The image display device according to claim 3, wherein
the ion generating unit, the blower, and the control circuit are disposed in stated order inside the second case.

5. The image display device according to claim 3, wherein
the ion generating unit and the control circuit are thermally isolated from the outside of the second case by being accommodated in the second case.

6. The image display device according to claim 1, further comprising
a guide member guiding the air including the ion mist emitted from the air outlet of the second case to the viewing space in front of the display panel.

7. A television receiver having a tuner which receives a broadcast wave, the television receiver comprising:
a display panel displaying an image contained in the broadcast wave received by the tuner;
a first case accommodating the display panel;
an ion generating unit generating ion mist;
a second case accommodating the ion generating unit; and
a blower disposed inside the second case and generating an air flow for emitting the ion mist generated by the ion generating unit to outside of the second case, wherein
the second case includes:
an air inlet provided in an upstream side of the ion generating unit; and
an air outlet for emitting the air including the ion mist and generated by the ion generating unit to the outside of the second case, and wherein
the air including the ion mist is emitted to a viewing space in front of the display panel.
